(19) United States
(12) Patent Application Publication
(10) Pub. No.: US 2006/0137845 A1
(43) Pub. Date: Jun. 29, 2006

(54) Leader cloth

(76) Inventor: Yasuyuki Ogiwara, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/315,133

(22) Filed: Dec. 23, 2005

(30) Foreign Application Priority Data
Dec. 27, 2004 (JP) 2004-375750

(51) Int. Cl. D21F 7/00; B32B 3/02

(52) U.S. Cl. 162/273; 226/92; 428/99

(57) ABSTRACT

The present invention relates to a leader cloth for pulling a new belt onto a paper machine and laying the same onto rolls when replacing a cloth or belt for paper machine. The configuration of the leader cloth according to the present invention is formed by an apex portion, a base portion, and right and left side edge portions connecting between each end portion of the base portion and the apex portion, and has a chevron-like shape substantially symmetrical with respect to a perpendicular line dropped from the center of the apex portion to the base portion as the axis of symmetry, and the left side edge portion is a curved line residing between two curved lines expressed by the following quadratic equation (1) and the following cubic equation (2), with respect to the width direction x and the longitudinal direction y; and the right side edge portion is a curved line substantially symmetrical with respect to the left side edge portion:
y=(b/a²)x² (1)
y=(b/a³)x³ (2) (In formula (1) and (2), “a” is a distance in width direction between the end of base portion and the end of apex portion; “b” is a distance between the base portion and the apex portion). According to the present invention, the tensile force is applied to the leader cloth entirely. Since there is no portion with the tensile force unapplied, such troubles can be prevented as belt sticking during pulling operation due to hanging down or ridge.

### TECHNICAL FIELD

The present invention relates to a leader cloth for pulling a new belt (referred to as new belt hereinafter) onto a paper machine and laying the same onto rolls when replacing a cloth or belt (referred to as belt hereinafter) for paper machine.

### BACKGROUND ART

In a paper machine for making paper, a belt, which has extremely large width, length and weight, is laid onto rolls, and processes such as squeezing water, conveying, drying and the like are carried out on wet paper while the belt runs on the rolls.

When the belt functions have been remarkably degraded, the belt is replaced with a new belt. In this case, the following works are required; i.e., machine has to be stopped; the used belt has to be removed; and then, a new belt has to be laid therein. Since the belt is large in size and heavy, in order to carry out replacing work safely and efficiently, the following method has been conventionally employed. That is, a used endless belt (referred to as old belt hereinafter) installed on rolls is cut off in the cross direction first; and then, the rear end of the old belt is joined to the leading end of a new belt. Then, the old belt is driven to run in the leading end direction to pull the new belt into the paper machine. After the new belt has been laid onto the entire rolls, the both ends of the belt are sewed together to form an endless belt on the rolls. However, in the above method, since the damaged used belt may be occasionally broken off while replacing the same with a new belt, the used belt is hard to be removed; or, it takes a lot of trouble to gradually remove the leading used belt out of the paper machine while pulling the new belt into the paper machine. Therefore, in these days, after removing the old belt, a rope is laid onto the rolls in the paper machine, a new belt is connected to the rope, and while pulling the rope, and the new belt is pulled onto the rolls in the paper machine.

To guide the new belt onto the rolls smoothly and precisely as described above, there is employed such a method that a fabric called as leader cloth is joined to the rear end of the rope, the leader cloth being connected to the end portion of the new belt, and tensile force by traction via the rope is transmitted to the new belt via the leader cloth to pull the same onto the rolls.

It is important for the leader cloth to uniformly transmit the tensile force of the traction via the rope to the entire area across the new belt width. If the tensile force is not uniform, the belt is displaced in the width direction or, twist, ridge or the like are caused. Thus, laying work onto the rolls is obstructed, or seams of the belt are damaged. As a result, the replaced belt for papermaking does not function satisfactorily. Also, to prevent the new belt end portion (after being laid onto the rolls, the end portion is joined to the other end as joint portion) from being damaged, such structure and material are required to be chosen as no large tensile force is incurred in the end portion.

To achieve the above object, various leader clothes of various configurations and materials have been proposed. For example, in U.S. Pat. No. 5,306,393 (Patent Document 1), there is proposed a leader cloth having such a structure that a fabric of a rectangular shape and a plurality of grommets provided to the end portion thereof at uniform intervals, by which a plurality of ropes are fixed to the fabric, ropes being bundled and hooked on a ring and pulled with another rope via the ring. However, in this method, tensile forces applied to the respective ropes are different from each other. Therefore, uniform tensile force is not applied across the leader cloth width direction, but new belt is pulled in a ridged state, and can not be guided precisely onto the rolls.

Also, in Translated National Publication of Patent Application No. 2003-502530 (Patent Document 2), there has been proposed a leader cloth having such a structure as three pieces rectangular shape materials for forming a triangular shape are laminated.

Further, in Translated National Publication of Patent Application No. 2003-514131 (Patent Document 3), as shown in FIG. 1, a leader cloth having a substantially triangular shape base material coated with polymer and reinforced with wires has been proposed.

[Patent Document 1] U.S. Pat. No. 5,306,393

[Patent Document 2] Translated National Publication of Patent Application No. 2003-502530

[Patent Document 3] Translated National Publication of Patent Application No. 2003-514131

### DISCLOSURE OF THE INVENTION

[Problem to be Solved by the Invention]

Leader cloths proposed in the Patent Document 2, 3 etc, have such configuration as triangle shapes in order to distribute the load uniformly. Even in the leader cloth having a configuration of a triangular shape, when pulled in the direction of the apex portion, the force is applied to the hatched portion only in FIG. 1. The portion other than the above is useless portion that does not contribute at all to pulling force transmission to a new belt. Not only useless but also the portion where receives no tensile creates hanging down or twist while pulling the leader cloth, causing a trouble such that the leader cloth is caught by nip portion during passing through the rolls, and further causing a disturbance in the traveling of the new roll body resulting in a displacement while installing the belt onto the rolls.

### MEANS FOR SOLVING THE PROBLEMS

The inventor of the present invention examined configuration of the leader cloth so that disadvantages of the leader cloth in the conventional method can be solved, and the leader cloth can be installed onto the rolls smoothly and precisely. As a result, the inventor found the fact that the above troubles can be eliminated by forming the both side edge portions to be such a specific shape as a curved one so that the leader cloth configuration consists of only the area with uniform tensile force.

That is, the present invention is a leader cloth for pulling and installing a belt onto rolls in a paper machine,

wherein the configuration thereof is formed by an apex portion, a base portion, and right and left side edge portions connecting between each end portion of the base portion and the apex portion, and has a chevron-like shape substantially symmetrical with respect to a perpendicular line dropped from the center of the apex portion to the base portion as the axis of symmetry, and the left side edge portion is a curved line residing between two curved lines expressed by the following quadratic equation (1) and the following cubic equation (2), with respect to the width direction x and the longitudinal direction y; and the right side edge portion is a curved line substantially symmetrical with respect to the left side edge portion:
y=(b/a²)x² (1)
y=(b/a³)x³ (2)
(in formula (1) and (2), “a” is a distance in width direction between the end of base portion and the end of apex portion; “b” is a distance between the base portion and the apex portion).

A preferred embodiment of the present invention is the leader cloth using a nonwoven fabric of which tensile strength is 400 to 1000 N/cm, preferably, 500 to 700 N/cm; and elongation ratio is 40 to 80%, preferably, 50 to 70%.

Further, in the preferred embodiment of the present invention, a leader cloth material with water repellency having a contact angle of 50° or more formed by the reference face of the material and the a water droplet placed thereon is used.

### EFFECT OF THE INVENTION

According to the present invention, since the both side edges connecting between the apex portion and the base portion are formed in a specific curved shape, the tensile force is applied to the leader cloth entirely. Since there is no portion with the tensile force unapplied, such troubles can be prevented as belt sticking during pulling operation due to hanging down or ridge.

Also, in the present invention, a nonwoven fabric having the above-described specific tensile strength and elongation ratio is employed as the material for the leader cloth. Accordingly, such effect that the leader cloth is prevented from breakage while installing a new belt can be obtained.

Further, in the present invention, a material with the specific water repellency is employed as the material for the leader cloth. Accordingly, the leader cloth can be prevented from being partially deformed or degrading in strength due to wet while pulling and installing a new belt onto the rolls in the paper machine.

### MEANS FOR CARRYING OUT THE INVENTION

Configuration of a leader cloth in accordance with the present invention includes an apex portion provided at one end in the direction being pulled towards rolls of a paper machine, and a connecting member for connecting to a rope is provided in the apex portion; the other end forms a base portion having the same width as that of a belt, to be connected to a new belt; and the both end portions, the apex and the base portion, are connected with both side edges, which have a specific curved shape, forming a shape of chevron.

What is essential for the leader cloth is that, when the leader cloth is pulled in the rolls in the paper machine, tensile force is transmitted uniformly across the width direction of the new belt, and hence any trouble such as hanging down, ridge and twist of the belt does not occur in the leader cloth itself while installing the belt, as well as no belt displacement occurs in installation. To this end, the selection of the plane configuration of the leader cloth, particularly the shape of the side edge portions is important.

A conventional leader cloth has a substantially triangular shape configuration as shown in FIG. 1, in which a base portion 11 and an apex portion 12 are connected with straight side edge portions 13. In the leader cloth having a triangular shape as described above, the portions S adjacent to the side edge portions 13 do not contribute to the transmission of the tensile force between an old belt and a new belt; not only this but also these portions receive no tensile force, therefore ridge or twist is generated during the pulling process, which causes a trouble.

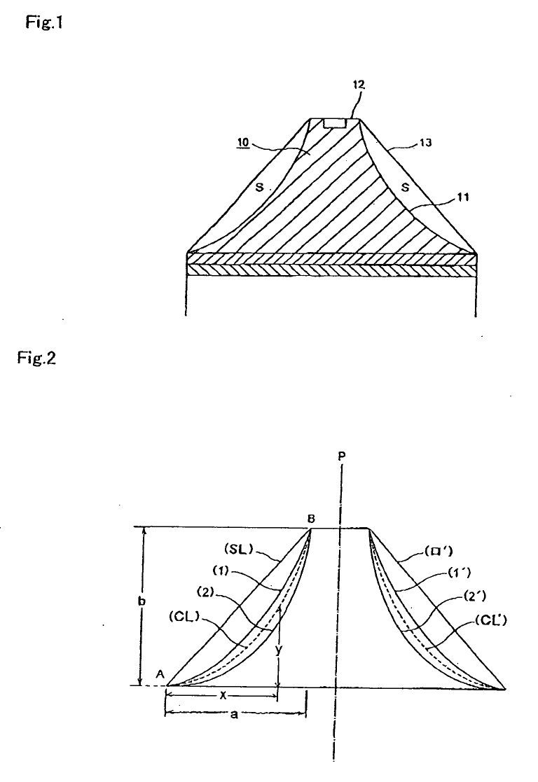

In the present invention, in order to solve the above problems, the side edge portions are formed in a specific shape having a curved line. That is, in the present invention, the curved lines of the both side edges, connecting the both end portions, that is, the base portion and the apex portion, reside between two curved line expressed by the following quadratic equation (1) and the following cubic equation (2) with respect to the width direction x and the longitudinal direction y. The configuration of the leader cloth is substantially symmetrical with respect to an axis of symmetry, which is a line P drawn perpendicular to the base portion from the apex portion. The sideline portion at the left side is a line, which connects the left end A of the base portion and the left end B of the apex portion in FIG. 2. In the conventional leader cloth having an isosceles triangle shape, the sideline portion is a straight line (SL). To express using a coordinate system including a point A as the origin, the relationship between x and y is expressed with a linear expression of y=(b/a) x. Contrarily, in the present invention, the sideline is a curve (CL), which resides amid the quadratic equation expressed with the following formula (1) and a cubic equation expressed with the following formula (2). On the other hand, the side edge portion at the right side is a curve substantially symmetrical with respect to the side line at the left side.
y=(b/a²)x² (1)
y=(b/a³)x³ (2)
(in formula (1) and (2), “a” is a distance in width direction between the end of base portion and the end of apex portion; “b” is a distance between the base portion and the apex portion).

Plane configuration of the leader cloth is a chevron-like shape as shown in FIG. 2, which is formed connecting the base portion and the apex portion with the left side edge portion curve (CL) and the right side edge portion curve (CL′), which is symmetrically positioned thereto. This is a configuration in which the areas S in FIG. 1 are removed from the isosceles triangle of the conventional leader cloth. The removed portions are the portions receiving no tensile force when the leader cloth is pulled onto the rolls in the paper machine. Therefore, the removed portions can cause troubles such as ridges, twists or the like in the pulling work.

Meanwhile, in the case of y<(b/a³)x³, that is, when the side edge resides in the side inner than the cubic curve (2) in FIG. 2, the area of the leader cloth is too small. Accordingly, the tensile force is concentrated on a narrow portion, resulting in an insufficient strength.

The apex portion is provided with a connecting member for hooking a rope for pulling a new belt onto the rolls in the paper machine. As the connecting member, a hook attached with a rope, a grommet fixed with a rope, a metal rod with a rope where an apex portion is folded back to enclose a metal rod provided in the width direction, and the central portion of the apex portion is cut off to expose the metal rod, to which a rope is joined, or the like is available.

A mounting member is provided to the base portion, which connects the end portion of the new belt when pulling in and disconnects therefrom after pulling in. As for the mounting member, a fastener is optimum.

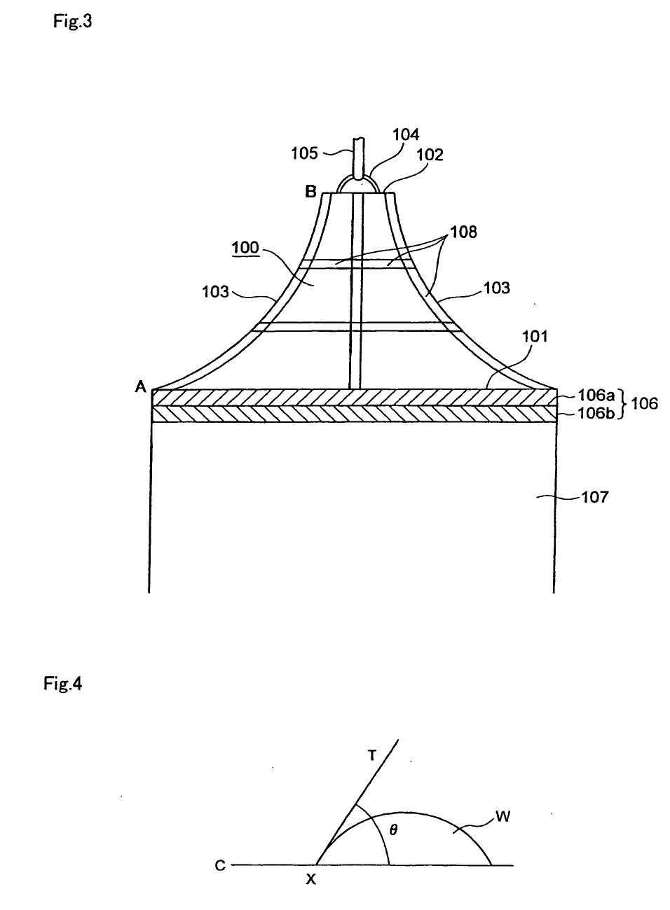

Hereinafter, referring to drawings, the leader cloth in accordance with the present invention will be described. FIG. 3 is a plan view of a leader cloth in accordance with the present invention. The leader cloth 100 shown in FIG. 3 has a configuration of a chevron-like shape formed by a base portion 101, an apex portion 102 and side edge portions 103.

In the left half area indicated with the base portion and the perpendicular line drawn from the apex portion to the base portion, the apex portion and the base portion are connected with the curved side edge portion 103, which resides between a quadratic expression (1), y=(b/a²)x², and a cubic equation (2), y=(b/a³)x³, in a coordinate system having the left end A of the base portion as the origin of a coordinate. And the right half area indicated with the base portion and the perpendicular line drawn from the apex portion to the base portion is in a substantially symmetrical relationship with the left half, constituting the right half of the leader cloth 100 in FIG. 3.

In the apex portion 102, a connecting member for pulling the leader cloth, for example, a hook 104 is provided and a rope 105 is attached thereto.

The base portion 101 is provided with a piece of the fastener 106a, and is connected to an end portion 107 of a new belt via another piece 106b.

When installing a new belt onto the paper machine, the end portion 107 of the new belt is attached to the leader cloth using the fastener 106b. On the other hand, the rope 105 attached to the apex portion of the leader cloth is laid around within the paper machine, and runs on the rolls along the traveling direction of the belt; thereby the new belt is guided by the leader cloth and pulled into the paper machine. Here, since the configuration of the leader cloth is optimized in accordance with the present invention and the load applied to the leader cloth is uniformly distributed within the leader cloth, no deformed portion such as sagging, ridge or the like exists. When the new belt runs around all rolls and the both ends thereof come to close to each other, the leader cloth is removed from the new belt, and the both ends of the new belt are joined together by sewing or the like; thus installation of the new belt is completed.

In addition, it is preferable to provide one or a plurality of reinforcement wires 108 made of high molecular compound in order to enhance the strength. As for the direction, the wires may be provided in a vertical direction, horizontal direction, along the side edges, or in the plurality of directions in combination of the above.

The material for the leader cloth has to bear the force pulling the belt, which has an extremely large weight. Therefore, a high strength fabric is required. A nonwoven fabric or the like fabricated from compound or natural fiber made of, for example, polyamide, polyester fabric, or various materials is employed.

As conventional material for the leader cloth, for example, as described in the Patent Document 3, such material as fabric like polyamide fiber or polyester fiber coated with a polymer material such as polyvinyl chloride has been preferably used. However, polymer fibers like polyvinyl chloride, polyethylene have such a disadvantage that the elongation ratio is small and hence a breakage tends to happen while pulling into the paper machine. Contrarily, when using a nonwoven fabric having a specific elongation ratio, elongation absorbs tensile force and breakage trouble as in the case of coated material can be prevented. A preferred embodiment in the present invention is a leader cloth employing a nonwoven fabric of which tensile strength is 400 to 1000 N/cm, preferably, 500 to 700 N/cm; the elongation ratio is 40 to 80%, preferably, 50 to 70%.

Nonwoven fabric includes fabrics fabricated in various methods. In particular, fabrics fabricated by means of spun-bonding, spun lacing, melt blowing, needle punching or the like are preferred.

Also, materials conventionally used for the leader cloth has a problem such as partial deformation or degrading in strength due to wet. It was found that a cloth imparted with the water repellency is effective to prevent such trouble. As for the material having the water repellency, materials coated with a silicon resin or fluorinated resin or the above materials finished in a manner of radical, etching, graft or the like, may be employed.

To prevent the above-mentioned trouble due to wet, a material with the water repellency having the contact angle of 50° or more is effective. The wording “contact angle” means an angle θ formed by tangent line T on a droplet and the a solid surface C at a contact point X between the solid and the droplet when the droplet W is placed on the surface of solid C as shown in FIG. 4. As for the measuring method of the contact angle, a drop is placed on a fabric material first; and its image is taken from the horizontal direction using an optical microscope. On the image, a tangent line of the droplet at the contact point X is drawn, and the contact angle is measured. To carry out the steps precisely and easily, it is preferred to process using a computer in the following manner. That is, the image taken by the optical microscope is read by a scanner into the computer. After appropriate processing for making the image clear, a tangent line is drawn from the contact point X to the droplet using an image processing software; thus contact angle (θ) is measured.

As for the material for the reinforcing wires, a high molecular compound such as polyester, polyamide, polyethylene, polypropylene, polyurethane, polystyrene, epoxy resin, polyvinyl chloride or polycarbonate is used after forming into the wire.

### INDUSTRIAL APPLICABILITY

The present invention is a leader cloth having a novel configuration, which is a guide member for installing a new belt into a paper machine. By employing the leader cloth, the tensile force while pulling the belt onto the rolls in the paper machine is uniformly distributed to the entire area of the leader cloth, and uniformly transmitted to the entire area in the width direction of the new belt. Owing to this, portions in the leader cloth and the new belt that are free from the tensile force are eliminated. Therefore, wave, ridge or the like of the leader cloth while installing is eliminated. Accordingly, the new belt is precisely guided and installed in a proper position of the rolls without giving any damage to the joint portion; thus, the new belt after replacement for paper machine can work without any obstructions.

### DESCRIPTION OF THE DRAWINGS

[FIG. 1] A plan view of a conventional leader cloth.

[FIG. 2] A curve of side edge portion in the leader cloth in accordance with the present invention.

[FIG. 3] A plan view of a leader cloth in accordance with the present invention.

[FIG. 4] A diagram illustrating water repellency.

### EXPLANATION OF REFERENCE NUMERALS

10 conventional leader cloth
11 base portion
12 apex portion
13 side edge portion
100 leader cloth of the present invention
101 base portion
102 apex portion
103 side edge portion
104 hook
105 rope
106 fastener
106a a piece of the fastener (leader cloth side)
106b a piece of the fastener (belt side)
107 belt end portion
108 reinforcement member
C solid surface
W droplet
X contact point
T tangent line

1. A leader cloth for pulling and installing a belt onto rolls in a paper machine, wherein the configuration thereof is formed by an apex portion, a base portion, and right and left side edge portions connecting between each end portion of the base portion and the apex portion, and has a chevron-like shape substantially symmetrical with respect to a perpendicular line dropped from the center of the apex portion to the base portion as the axis of symmetry, and the left side edge portion is a curved line residing between two curved lines expressed by the following quadratic equation (1) and the following cubic equation (2), with respect to the width direction x and the longitudinal direction y; and the right side edge portion is a curved line substantially symmetrical with respect to the left side edge portion:
y=(b/a²)x² (1)
y=(b/a³)x3 (2)
(in formula (1) and (2), “a” is a distance in width direction between the end of base portion and the end of apex portion; “b” is a distance between the base portion and the apex portion).

2. The leader cloth according to claim 1, wherein the leader cloth is fabricated from a nonwoven fabric material of which tensile strength is 400 to 1000 N/cm, and the elongation ratio is 40 to 80%.

3. The leader cloth according to claim 2, wherein the leader cloth is fabricated from a nonwoven fabric material of which tensile strength is 500 to 700 N/cm, and the elongation ratio is 50 to 70%.

4. The leader cloth according to claim 1, wherein the material for the leader cloth is a fabric material with a water repellency having contact angle of 50° or more formed by a reference face of the material and a droplet of water placed thereon.

5. The leader cloth according to any of claims 1 to 4 claim 1, wherein the fabric material is provided with one or a plurality of reinforcing wires of a high molecular compound.

6. The leader cloth according to claim 5, wherein the reinforcing wire is a formed cord material of a high molecular compound selected from polyester, polyamide, polyethylene, polypropylene, polyurethane, polystyrene, epoxy resin, polyvinyl chloride and polycarbonate.

7. The leader cloth according to claim 2, wherein the material for the leader cloth is a fabric material with a water repellency having contact angle of 50° or more formed by a reference face of the material and a droplet of water placed thereon.

8. The leader cloth according to claim 3, wherein the material for the leader cloth is a fabric material with a water repellency having contact angle of 50° or more formed by a reference face of the material and a droplet of water placed thereon.

9. The leader cloth according to claim 2, wherein the fabric material is provided with one or a plurality of reinforcing wires of a high molecular compound.

10. The leader cloth according to claim 3, wherein the fabric material is provided with one or a plurality of reinforcing wires of a high molecular compound.

11. The leader cloth according to claim 4, wherein the fabric material is provided with one or a plurality of reinforcing wires of a high molecular compound.
